(19) United States
(12) Patent Application Publication
(10) Pub. No.: US 2025/0226937 A1
(43) Pub. Date: Jul. 10, 2025

(54) PREAMBLE DETECTION AND POWER LEVEL MEASUREMENT FOR ENHANCED LONG-RANGE (ELR) MODE OF ULTRA HIGH RELIABILITY (UHR) WLANS

(71) Applicants: Qinghua Li, San Ramon, CA (US); Po-Kai Huang, San Jose, CA (US); Juan Fang, Portland, OR (US); Laurent Cariou, Milizac (FR); Danny Alexander, Neve Efraim Monoson (IL); Assaf Gurevitz, Ramat Hasharon (IL); Liam Jacob Alfandary, Santa Clara, CA (US); Shlomi Vituri, Tel Aviv (IL)

(72) Inventors: Qinghua Li, San Ramon, CA (US); Po-Kai Huang, San Jose, CA (US); Juan Fang, Portland, OR (US); Laurent Cariou, Milizac (FR); Danny Alexander, Neve Efraim Monoson (IL); Assaf Gurevitz, Ramat Hasharon (IL); Liam Jacob Alfandary, Santa Clara, CA (US); Shlomi Vituri, Tel Aviv (IL)

(21) Appl. No.: 19/094,508

(22) Filed: Mar. 28, 2025

Related U.S. Application Data
(60) Provisional application No. 63/575,449, filed on Apr. 5, 2024.
(60) Provisional application No. 63/657,471, filed on Jun. 7, 2024.

(51) Int. Cl. H04L 5/00; H04W 52/02; H04W 84/12

(52) U.S. Cl. CPC H04L 5/0044; H04W 52/02; H04W 84/12

(57) ABSTRACT

A wireless device configured for communication in a wireless local area network (WLAN) may determine whether a detected physical layer protocol data unit (PPDU) is an enhanced long range (ELR) PPDU or a non-ELR PPDU and may estimate a power level for a data field of the detected PPDU. The device may use the estimated power level for determining a PHY-CCA indication primitive. The estimated power level for an ELR data field may be determined based on predetermined power boost levels of one or more fields in the ELR PPDU. For a spatial reuse transmission, a transmit power level may be determined based on the estimated power level for the ELR data field. A ELR PPDU may comprise a legacy preamble followed by a ELR preamble and an ELR data field. The ELR preamble may comprise an ELR classification field followed by an ELR-STF, an ELR-LTF and an ELR-SIG.

### PRIORITY CLAIM

This application claims priority under 35 USC 119(e) to U.S. Provisional Patent Application Ser. No. 63/575,449, filed Apr. 5, 2024 [reference number AG0642-Z] and U.S. Provisional Patent Application Ser. No. 63/657,471, filed Jun. 7, 2024 [reference number AG1879-Z], which are incorporated herein by reference in their entireties.

### TECHNICAL FIELD

Embodiments pertain to wireless communications. Some embodiments relate to wireless local area networks (WLANs). Some embodiments relate to IEEE 802.11 networks.

### BACKGROUND

The Ultra High Reliability (UHR) study group is expected to lead to the creation of a task group that will develop the IEEE 802.11bn amendment to the IEEE 802.11 standards which will form the basis of Wi-Fi 8. An enhanced long range (ELR) mode is proposed for the IEEE 802.11bn amendment that is intended to improve the reliability of connections such that the user experience gets improved. One issue with ELR mode is that an ELR physical layer protocol data unit (PPDU) may be different than legacy and non-ELR PPDUs and thus some portions of an ELR PPDU may be unreadable for devices not supporting ELR mode and complicating power level measurements. Another issue with ELR mode is that ELR PPDUs may have a lower signal-to-noise (SNR) making it more challenging to detect a preamble.

Therefore, what is needed are techniques for updating a device's network allocation vector (NAV) based on receipt of an ELR PPDU. What is also needed are techniques for determining a power level of a received ELR PPDU for spatial reuse and for determining a physical layer clear channel assessment (PHY-CCA) indication primitive for determining whether the channel is busy. What is also needed are improved preamble detection techniques for ELR PPDUs.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG.1, in accordance with some embodiments.

FIG. 5 illustrates a WLAN, in accordance with some embodiments.

FIG. 6 illustrates an enhanced long range (ELR) PPDU, in accordance with some embodiments.

FIG. 7A, FIG. 7B, and FIG. 7C illustrate ELR PPDUs with different ELR preamble structures, in accordance with some embodiments.

FIG. 8A illustrates a baseband signal of the L-STF in the time domain, in accordance with some embodiments.

FIG. 8B illustrates a distorted baseband signal of the L-STF in the time domain, in accordance with some embodiments.

FIG. 8C illustrates a power spectrum mask and the power spectrum of the distorted L-STF of FIG. 8B, in accordance with some embodiments.

FIG. 8D illustrates a modified Zadoff-Chu signal in the time domain suitable for use as the L-STF, in accordance with some embodiments.

FIG. 8E illustrates distorted signal of FIG. 8D at an output of the power amplifier, in accordance with some embodiments.

FIG. 8F illustrates a power spectrum mask and the power spectrum of the distorted signal of FIG. 8E, in accordance with some embodiments.

FIG. 9 illustrates a modified L-STF, in accordance with some embodiments.

FIG. 10A, FIG. 10B and FIG. 10C illustrate embodiments of an ELR-C field with a 1.6 microsecond period, in accordance with some embodiments.

FIG. 11A, FIG. 11B and FIG. 11C illustrate embodiments of an ELR-C field with a 3.2 microsecond period, in accordance with some embodiments.

FIG. 12 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to updating a device's network allocation vector (NAV) based on receipt of an ELR PPDU. Some embodiments are directed to determining a power level of a received ELR PPDU for spatial reuse and/or for determining a physical layer clear channel assessment (PHY-CCA) indication primitive for determining whether the channel is busy. Some embodiments are directed to preamble detection techniques for ELR PPDUs.

In some embodiments, a wireless communication device configured for communication in a wireless local area network (WLAN) may determine whether a detected physical layer protocol data unit (PPDU) is an enhanced long range (ELR) PPDU or a non-ELR PPDU and may estimate a power level for a data field of the detected PPDU. The device may use the estimated power level for the data field for determining a PHY-CCA indication primitive. The estimated power level for an ELR data field may be determined based on one or more predetermined power boost levels of one or more fields in the ELR PPDU. For a spatial reuse transmission, a transmit (TX) power level may be determined based on the estimated power level for the ELR data field. These embodiments are described in more detail here.

In some embodiments, an ELR PPDU may be detected based at least in part by performing autocorrelation on a legacy short training field (L-STF) and autoclassification based on an ELR control field (ELR-C). In some embodiments, a ELR PPDU may comprise a legacy preamble portion followed by a ELR preamble portion and an ELR data field (ELR-DATA) following the ELR preamble portion. The legacy preamble portion may comprise a legacy short training field (L-STF) followed by a legacy long training field (L-LTF), a legacy signal field (L-SIG), a repeated legacy signal field (RL-SIG), and a universal signal field (U-SIG). The ELR preamble portion may comprise an ELR classification field followed by an ELR-STF, an ELR-LTF and an ELR-SIG. In some embodiments, the L-STF may have a 0.8 microsecond periodicity, the L-STF and the ELR-C may both comprise a sequence of phase coded pulses (SPCP) applied on subcarriers in frequency domain, and the ELR-C may have a duration of one or more multiples of 4 microseconds. In some embodiments, when multiple antennas are used to transmit the ELR PPDU and when the ELR-STF is included in the ELR PPDU, the transmitting device may refrain from beamforming the legacy preamble portion and the ELR-C and may perform beamforming on the ELR-STF, ELR-LTF, the ELR-SIG and the ELR-DATA, although the scope of the embodiments is not limited in this respect.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments are not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE Std 802.11-2021 IEEE 802.11-2020, IEEE P802.11be and/or IEEE P802.11bn standards and/or proposed specifications for WLANs, which are incorporated herein by reference in their entireties. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE P802.11be standard. In some embodiments, the radio architecture 100 may be configured for Enhanced Long Range (ELR) communications in accordance with the IEEE P802.11bn standard.

In these embodiments, the radio architecture 100 may be configured to communicate in accordance with an OFDMA technique, although the scope of the embodiments are not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments are not limited in this respect.

In some embodiments, as further shown in FIG. 1, the BT baseband processing circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments are not limited in this respect. In some of these embodiments that include a BT functionality, the radio architecture may be configured to engage in a BT Asynchronous Connection-Less (ACL) communications, although the scope of the embodiments are not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments are not limited with respect to the above center frequencies.

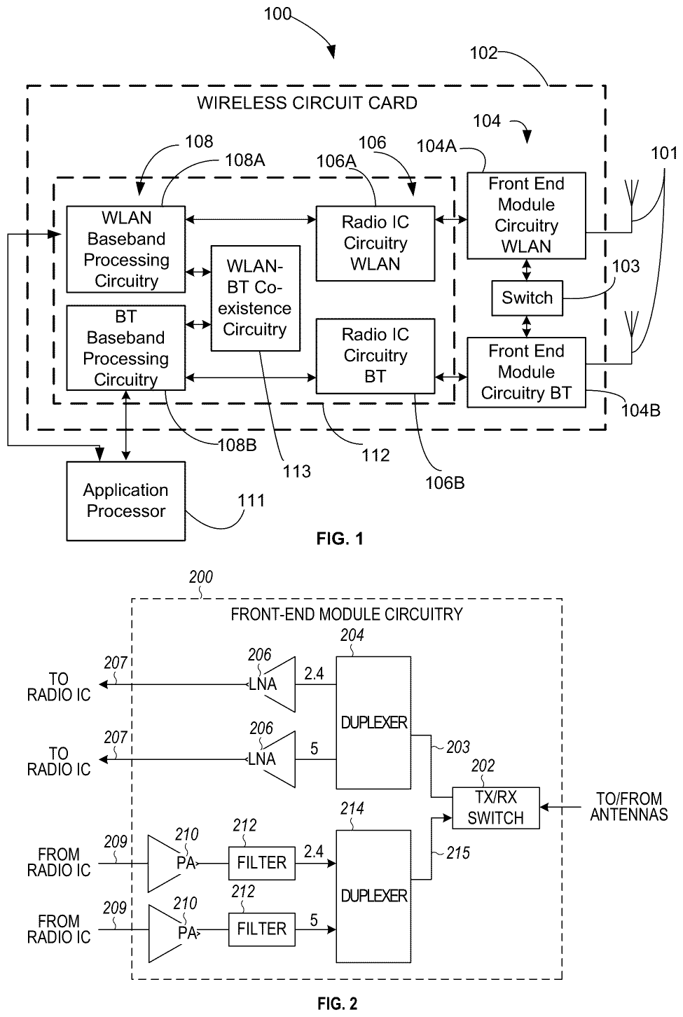

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHz signal paths and may utilize the same FEM circuitry 200 as the one used for WLAN communications.

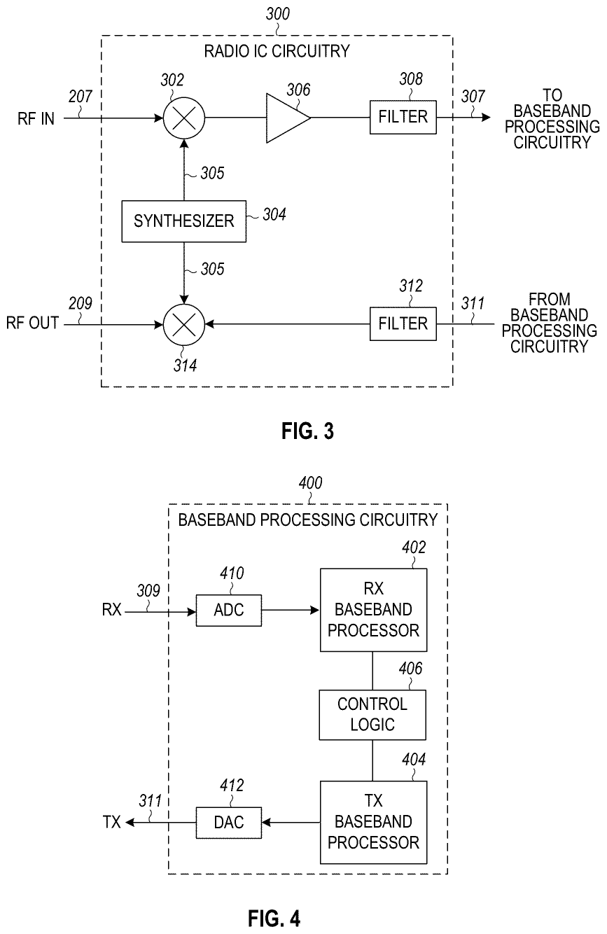

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments are not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments are not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLo) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments are not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments are not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments are not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments are not limited in this respect.

In some embodiments, the synthesizer circuitry 304 may be a fractional-N synthesizer or a fractional N/N+1 synthesizer, although the scope of the embodiments are not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage-controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

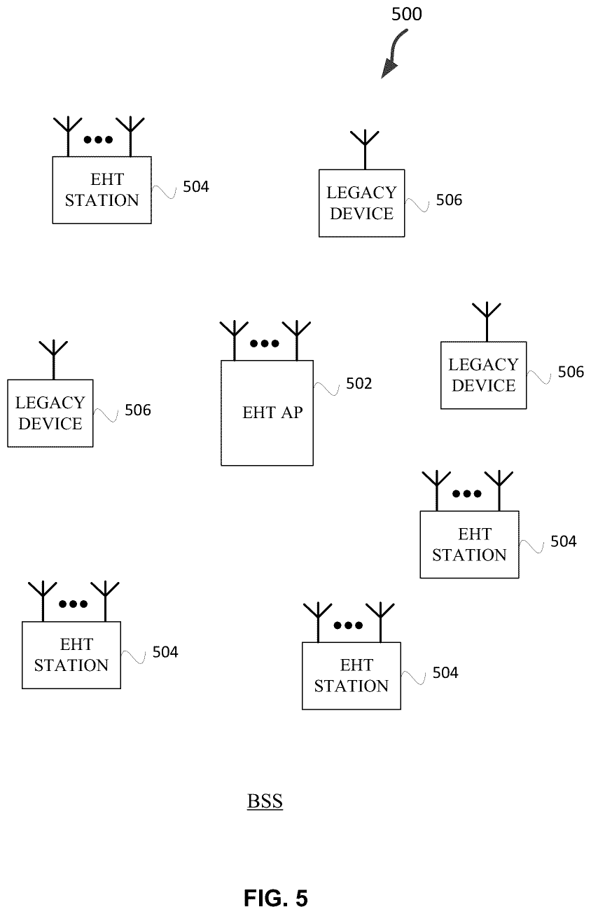

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+ STAs. In some embodiments, WLAN 500 may be configured for Enhanced Long Range (ELR) communications in accordance with one of the IEEE 802.11 standards or draft standards and one or more stations including AP 502 and stations 504 may be ELR AP and/or ELR STAs. In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 standards or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats. A frame may be configured for transmitting a number of spatial streams, which may be in accordance with MU-MIMO and may be in accordance with OFDMA.

In accordance with some IEEE 802.11 embodiments, AP 502 may operate as a primary station which may be arranged to contend for a wireless medium (e.g., during a contention period) to receive exclusive control of the medium for a control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement. Some embodiments are directed to an apparatus of a STA configured for operation in a WLAN comprising processing circuitry and memory. In some embodiments station 504 may be a “group owner” (GO) for peer-to-peer modes of operation. A wireless device may be a station 504 or an AP 502.

In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

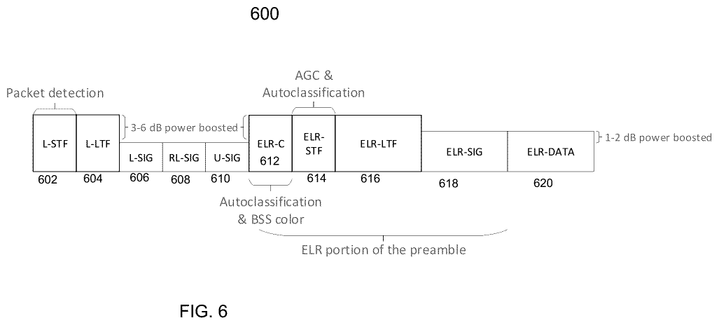

FIG. 6 illustrates an enhanced long range (ELR) PPDU, in accordance with some embodiments. The ELR PPDU 600 comprises a legacy preamble portion followed by a ELR preamble portion, the legacy preamble portion comprises a legacy short training field (L-STF) 602, followed by a legacy long training field (L-LTF) 604, a legacy signal field (L-SIG) 606, a repetition of the L-SIG (RL-SIG) 608, and a universal signal field (U-SIG) 610, The ELR preamble portion comprises an ELR classification field (ELR-C) 612 followed by an ELR-STF 614, an ELR-LTF 616 and an ELR-SIG 618. An ELR data field (ELR-DATA) 620 may follow the ELR preamble portion. In these embodiments, the L-STF and the L-LTF may be power boosted at transmission by a first predetermined power boost level (e.g., 3-6 dB) compared to the L-SIG, the RL-SIG, the U-SIG, the ELR-SIG, and ELR-DATA (which are not power boosted at transmission).

As mentioned above, IEEE 802.11bn is likely to have an enhanced long-range (ELR) mode which may utilized an ELR PPDU that is different from a non-ELR PPDU. Some portions of the ELR PPDU may be power boosted and some portions may be unreadable to devices not supporting ELR. Therefore, the channel access rules for spatial reuse and network allocation vector (NAV) update need to be addressed.

Embodiments disclosed herein address several issues with ELR PPDUs. First, because the L-STF and L-LTF of ELR PPDU may be power boosted by several dBs (e.g., 3-6 dBs), the power measurement of the PPDU (e.g., for spatial reuse and other reasons) needs to take the power boosting into account when estimating the received signal strength of ELR data portion or the power level of portions other than L-STF and L-LTF of the ELR PPDU may be measured. Second, unlike receiving the other types of PPDUs, it is likely that the receiver of an ELR PPDU may only know the TXOP duration but the BSS color from the PHY preamble. Therefore, the rules for updating the device's network allocation vector (NAV) may need to be determined.

Packet detection mainly relies on the L-STF, which may be power boosted by 3-6 dB, and the autoclassification, which identifies the ELR PPDU type, may be done at the ELR-STF. In some embodiments, the autoclassification may be done at a dedicated field (e.g., the ELR-C) which is right before the ELR-STF or right after the U-SIG and is not beamformed. For combating the noise, all (or some) of the L-STF, L-LTF, ELR-C, ELR-STF, and ELR-LTF may be power boosted by 3-6 dBs. For terminating the reception early, the BSS color may be encoded into a sequence sent in ELR-C. If the receiver finds a mismatch between its BSS color sequence and the received sequence, the receiver may terminate the reception. In this case, if the receiver wasn't able to get the TXOP duration from the U-SIG correctly (e.g., due to strong noise), the receiver doesn't get the TXOP duration to update the NAV.

Sequences (in frequency domain or time domain) may be used to signal the BSS color. Namely, the sequences to signal BSS colors may be carried in ELR-STF or ELR-LTF like in ELR-C. In addition, if ELR-C (or ELR-STF or ELR-LTF) carries the indication sequence for the BSS color, there may be no need for the ELR-SIG to carry the BSS color. On the other hand, the ELR-SIG may still carry the BSS color for backward compatibility or double check. It should be noticed that there are other ways to do the autoclassification other than using ELR-C and the ELR-C may not be included in the final version of ELR PPDU structure. The signal structure of ELR-C, ELR-STF, and ELR-LTF may also be used for the autoclassification. For example, the autoclassification may be done using the period of ELR-STF, which is different from 0.8 microsecond of a non-ELR PPDU.

### Power Measurement

The estimated power level an ELR PPDU may be used for determining a PHY-CCA.indication primitive as well for used for spatial reuse.

### Embodiments 1 for Power Measurement for an ELR PPDU

The exact power boost level may be defined in the standard (e.g., 3 dB or 4 dB, for L-STF and/or L-LTF). In these embodiments, the receiver measures the received signal strength of L-STF and/or L-LTF and then subtracts the defined power boost level to estimate the received signal strength of the ELR data portion.

Because the modulation and coding schemes (MCSs) of ELR-SIG and ELR-DATA are more reliable than the L-SIG, RL-SIG, and U-SIG, ELR-SIG and ELR-DATA can tolerate higher transmitter distortion measured by error vector magnitude (EVM) such that the transmission power of ELR-SIG and ELR-DATA may be higher than that of L-SIG, RL-SIG, and U-SIG by 1 or 2 dB. In this case, the estimation of the received signal strength of the ELR-DATA needs to consider the power boost of the ELR-DATA. For example, P_{ELR-DATA}=P_{ELR-STF/LTF}−B_{ELR-STF/LTF}+B_{ELR-DTA}, where P_{ELR-DATA} is the received signal strength of the ELR-DATA under estimation in dB, P_{ELR-STF/LTF} is the received signal strength measured at ELR-STF and/or ELR-LTF in dB, B_{ELR-STF/LTF} is the power boost of ELR-STF and/or ELR-LTF defined in the standard in dB, B_{ELR-DTA} is the power boost of ELR-DATA defined in the standard in dB. The compensated value, P_{ELR-DATA}, is used to determine PHY-CCA.indication primitive, which is defined in IEEE 802.11 standard, and to compare to the non-SRG OBSS PD level for compensating for the power difference in the spatial reuse transmission.

### Embodiments 2 for Power Measurement for an ELR PPDU

In Embodiments 1, the power boost levels may need to be defined in the standard and implemented exactly in the actual transmission. However, different chip vendors may prefer different levels of power boosting according to their power amplifier designs, respectively. Because of the uncertainty in the power boosting level, it may be difficult to estimate the received signal strength of the ELR-DATA from the received signal strength measured from L-STF and/or L-LTF. In this case, instead of L-STF and L-LTF, the received signal strength of another field may be measured for ELR PPDU. For example, if an ELR PPDU is identified (e.g., by the autoclassification in ELR-C or ELR-STF), the receiver may measure the received signal strength of the ELR-DATA (or ELR-SIG) directly. In another example, if the transmission power difference between ELR-STF (or ELR-LTF) and ELR-DATA is known (e.g., defined in the standard), then the received signal strength of ELR-STF (or ELR-LTF) may be used to estimate the received signal strength of ELR-DATA. The estimate of the received signal strength of ELR-DATA may be used to determine the PHY-CCA.indication primitive, which is defined in IEEE 802.11 standard, and used to compare to the non-SRG OBSS PD level for compensating for the power difference in the spatial reuse transmission.

### NAV Update for ELR PPDU

The ELR-PPDU may receive at a negative signal to noise ratio (SNR) in which the BSS color and TXOP duration in the U-SIG in FIG. 6 may not be decoded correctly. Because the BSS color carried by the ELR-C may be more reliable than that in U-SIG, it may be likely that the receiver receives the BSS color in ELR-C but doesn't receive the TXOP duration in U-SIG. If the received BSS color doesn't match the receiver's BSS color, the receiver may want to terminate the reception early. This is called BSS color filtering in PHY. However, it is unclear how to update the network allocation vector (NAV) in this case. In contrast, in the legacy cases, both BSS color and TXOP duration may be available simultaneously such that updating the NAV properly has no issue.

Regarding BSS color signaling, embodiments disclosed herein provide that the BSS color may be signaled in four places in the ELR PPDU, which are 1) the U-SIG, 2) the ELR-C (or ELR-STF or ELR-LTF), 3) the ELR-SIG, and 4) the MAC header of MPDU. If the BSS color is signaled in ELR-C (or ELR-STF or ELR-LTF), then the BSS color may not be signaled in ELR-SIG. In the MAC header of MPDU, BSS ID may be indicated. BSS ID (BSSID) may be the full ID of the cell and BSS color may be the shortened version of BSS ID.

Regarding the signaling of TXOP duration, besides the TXOP duration field in the U-SIG that is version independent, embodiments disclosed herein provide that the TXOP duration may be signaled in three places in the ELR PPDU, which are 1) the ELR-C (or ELR-STF or ELR-LTF), 2) the ELR-SIG, and 3) the MAC header of MPDU. The signaling in the ELR-C (or ELR-STF or ELR-LTF) may be less likely or feasible than the other two places. The TXOP duration in MAC header of MPDU has the finest resolution among the four, which has 16 bits. The TXOP duration in U-SIG and ELR-SIG may have 7 bits instead of 16 bits.

If the receiver decodes the finer version of BSS ID or TXOP duration, the receiver should use the finer version. For example, if the receiver decodes the MAC header of MPDU, then the receiver should use the TXOP duration and BSS ID in the header instead of the 6-bit BSS color and the 7-bit TXOP in U-SIG.

Besides the TXOP duration, there may be a PPDU duration, for which the receiver should defer its transmission at least. Namely, if the TXOP duration is available, the receiver should defer its transmission for the TXOP duration, which may be longer than the PPDU duration. If the TXOP duration is unavailable but the PPDU duration is available, the receiver should defer its transmission at least for the PPDU duration. The PPDU duration may be derived from the length field in L-SIG and RL-SIG. If the parity check and the validations of required MCS setting (e.g., MCS 0) and required length field setting (e.g., mod (LENGTH,3)=0) in L-SIG or RL-SIG all passed, the PPDU duration derived from L-SIG and RL-SIG may be used for the deferral. The validation of the L-SIG or RL-SIG for ELR PPDU should be mandatory. Otherwise, the PPDU duration may be obtained from ELR-SIG or the power drop detection of the received signal. The power drop detection may be hard for negative SNRs because the received signal power may be dominated by noise power. The ELR-SIG should have a CRC for validation.

If both the TXOP duration and PPDU duration are unavailable, e.g., due to the CRC failures, the standard may define a default, minimum duration for the receiver to hold its transmission. If the minimum duration is longer than the current NAV time, the NAV needs to be updated. The minimum duration should be defined in the standard. If the receiver's BSS color matches the BSS color indicated in the ELR-C and the minimum duration is longer than the TXOP duration indicated in the ELR-SIG or MAC header, the NAV needs to be updated according to the duration in ELR-SIG or MAC header not the minimum duration. If the receiver's BSS color does not match the BSS color indicated in the ELR-C and the receiver may just update the NAV using the minimum duration.

If the U-SIG CRC failed and the autoclassification of ELR PPDU failed, e.g., using the signal structure of ELR-C or ELR-STF or ELR-LTF, the receiver should hold its transmission for at least the duration of the ELR PPDU to prevent interfering with the reception of the on-going ELR PPDU if PPDU duration may be available from L-SIG and RL-SIG.

Using all the assumptions above, embodiments disclosed herein provide for updating the NAV after receiving an ELR PPDU. In Embodiments 1, no device is mandated to decode ELR-SIG. In Embodiments 2, all devices are mandated to decode ELR-SIG. Finally, in Embodiments 3, only device supporting the reception or transmission of ELR-DATA (or ELR-SIG) is mandated to decode ELR-SIG.

### Embodiments 1 for Updating the NAV for an ELR PPDU

In these embodiments, the CRC of the U-SIG in the receiving ELR PPDU is assumed failed and the receiver doesn't get a reliable TXOP duration and a reliable BSS color from the U-SIG in FIG. 6. Furthermore, the BSS color carried in the ELR-C (or ELR-STF or ELR-LTF or ELR-SIG) is assumed to be decoded correctly and the decoded BSS color doesn't match the receiver's own BSS color. Under two assumptions, embodiments disclosed herein provide that the receiver doesn't update its NAV. Because the receiver decodes ELR-C correctly, the receiver essentially finished the autoclassification of the ELR PPDU. Namely, it is sure that the receiver detected an ELR PPDU. Although the TXOP duration is unavailable, if the autoclassification is done or the arrival of an ELR PPDU preamble is detected, it is desirable that the receiver may just defer its transmission for the whole PPDU duration. The PPDU duration may be derived from the length field in L-SIG and RL-SIG. If the parity check and the validations of required MCS setting and required length field setting in L-SIG or RL-SIG all passed, the PPDU duration derived from L-SIG and RL-SIG may be used for the deferral. Otherwise, the PPDU duration may be obtained from ELR-SIG or the power drop detection of the received signal. The power drop detection may be hard for negative SNRs because the received signal power may be dominated by noise power. The ELR-SIG should have a CRC for validation.

If the PPDU duration is unavailable, the receiver may fall back to the energy detect (ED) CCA or packet detect (PD) CCA again without deferral or with a certain deferral defined in the standard. This may be the simplest solution because it doesn't require all 11bn receivers to support the reception of ELR-SIG or effectively ELR preamble. However, without updating the TXOP duration, ELR devices with different BSS colors may interfere with each other by ignoring the on-going ELR transmission.

If the decoded BSS color in ELR-C (or ELR-STF or ELR-LTF) matched the receiver's and the receiver supports the reception of ELR PPDU, the receiver should continue to decode ELR-SIG (and ELR-DATA). If the receiver does not support the decoding of ELR-SIG, the receiver may use PPDU duration for transmission deferral if available because the TXOP duration may be unavailable due to U-SIG CRC failure.

### Embodiments 2 for Updating the NAV for an ELR PPDU

With the first assumption in Embodiments 1, embodiments disclosed herein provide that the standard may mandate that all 11bn devices support the reception or decoding of ELR-SIG, i.e., the reception of the whole preamble of ELR PPDU. If this requirement holds, then the receiver should continue to decode the ELR-SIG for getting the TXOP duration and/or BSS color after the CRC of U-SIG failed. If the CRC of ELR-SIG passed, the receiver should use the TXOP duration and BSS color in the ELR portion of the PHY preamble to update NAV. If the decoded BSS color doesn't match the receiver's, the receiver may terminate the reception early not decoding the MAC header of MPDU. Otherwise, the receiver may decode the MAC header of MPDU and use the BSS ID and TXOP duration with more bits for the NAV update. In These embodiments, because all 11bn devices need to decode the ELR-SIG, there may be no need to signal the BSS color in ELR-C (or ELR-STF or ELR-LTF or ELR-SIG). Because all the devices may need to decode a robust ELR-SIG, these embodiments reduce the interference among all 11bn devices at the cost of complexity.

If TXOP duration is unavailable (e.g., due to CRC failure), the receiver may use PPDU duration for transmission deferral as Embodiments 1 if available. If the PPDU duration is also unavailable, the receiver may defer the transmission as Embodiments 1.

### Embodiments 3 for Updating the NAV for an ELR PPDU

These embodiments are a slight variant of Embodiments 2. It relaxes the requirement for 11bn devices not supporting the reception of ELR-DATA. With the first assumption in Embodiments 1, embodiments disclosed herein provide the following. The standard may mandate that 11bn devices, which support ELR-DATA reception and/or transmission, should decode the ELR-SIG for TXOP duration (and BSS color) if the U-SIG's CRC fails. If ELR-SIG's CRC passes, the receiver should use the TXOP duration in ELR-SIG or the one in MAC header of MPDU for NAV update for NAV update. For devices not supporting ELR-DATA reception and/or transmission, they may not update NAV after U-SIG CRC failed. Because all the ELR devices have higher sensitivities than the non-ELR devices, these embodiments may reduce the interference only among the ELR devices.

If TXOP duration is unavailable, the receiver may use PPDU duration for transmission deferral as Embodiments 1. If the PPDU duration is also unavailable, the receiver may defer the transmission as Embodiments 1. In These embodiments, the category of supporting the reception/transmission of ELR-DATA may be replaced by the category of supporting the reception and/or transmission of ELR-SIG.

In accordance with embodiments, a wireless communication device configured for communication in a wireless local area network (WLAN) may determine whether a detected physical layer protocol data unit (PPDU) is an enhanced long range (ELR) PPDU or a non-ELR PPDU and may estimate a power level for a data field of the detected PPDU. In these embodiments, the device may use the estimated power level for the data field for determining a PHY-CCA indication primitive.

In some of these embodiments, when an ELR PPDU is detected, the data field is an ELR data field and the estimated power level for the ELR data field may be determined based on one or more predetermined power boost levels of one or more fields in the ELR PPDU. In these embodiments, the device may be an access point (AP) AP station (STA) 502 (FIG. 5) or a non-AP STA 504 (FIG. 5) and the WLAN may be an IEEE 802.11 network. The device may be an UHR device operating in accordance with an IEEE 802.11bn standard.

In some embodiments, the ELR PPDU 600 (see FIG. 6) comprises a legacy preamble portion followed by a ELR preamble portion. The legacy preamble portion may comprise a legacy short training field (L-STF) 602, followed by a legacy long training field (L-LTF) 604, a legacy signal field (L-SIG) 606, a repetition of the L-SIG (RL-SIG) 608, and a universal signal field (U-SIG) 610. The ELR preamble portion may comprise an ELR classification field (ELR-C) 612 followed by an ELR-STF 614, an ELR-LTF 616 and an ELR-SIG 618. The ELR data field (ELR-DATA) 620 may follow the ELR preamble portion. In these embodiments, the L-STF and the L-LTF may be power boosted at transmission by a first predetermined power boost level (e.g., 3-6 dB) compared to the L-SIG, the RL-SIG, the U-SIG, the ELR-SIG, and ELR-DATA (which are not power boosted at transmission).

In some of these embodiments, a non-ELR PPDU will not have an ELR preamble portion. In some embodiments, the ELR-C, the ELR-STF and the ELR-LTF of an ELR PPDU may also be power boosted by the first predetermined power boost level (e.g., as illustrated in FIG. 6), although the scope of the embodiments is not limited in this respect, as in some other embodiments, the ELR-C, the ELR-STF and the ELR-LTF are not power boosted. In some embodiments, (e.g., as illustrated in FIG. 6), the ELR-SIG and the ELR-DATA may be power boosted at transmission by a second predetermined power boost level (e.g., 1-2 dB) compared to the L-SIG, the RL-SIG and the U-SIG (which are not power boosted at transmission), although the scope of the embodiments is not limited in this respect, as in some other embodiments, the ELR-SIG and the ELR-DATA are not power boosted.

In some embodiments, the ELR-C may have one or two symbols that carry a sequence known to the receiver to facilitate detection. In some embodiments, the ELR-C may be referred to as the ELR-Mark.

In some embodiments, the detected PPDU may be determined to be an ELR PPDU by autoclassification using primarily the ELR-C. In some embodiments, autoclassification may be performed using the period of ELR-STF, which is other than 0.8 microseconds (i.e., since non-ELR PPDUs may use an L-STF of 0.8 microseconds), although the scope of the embodiments is not limited in this respect. In some embodiments, the detected PPDU may be determined to be an ELR PPDU by autoclassification using a signal structure of the ELR preamble portion of the ELR PPDU.

In some embodiments, when the detected PPDU is determined to be an ELR PPDU, and when the U-SIG is unable to be decoded correctly (i.e., thus the BSS color and TXOP duration cannot be determined from the U-SIG), the device may update a network allocation vector (NAV) of the device based on a basic service set (BSS) color and signaled in one or more fields of the ELR preamble portion and a transmission opportunity (TXOP) duration signaled in a header of an MPDU present in the ELR-DATA; and

In these embodiments, when the detected PPDU may be determined to be a non-ELR PPDU, the device may update the NAV of the device based on a BSS color and a TXOP duration field signaled in the U-SIG of the non-ELR PPDU.

In these embodiments, when the BSS color of the detected PPDU does not match the BSS color of the receiver (i.e., the non-AP STA that detected the PPDU), the non-AP STA may terminate reception early (before the end of the PPDU)). In this early-termination situation, the TXOP duration is not determined from the header of the MPDU since the header is not read.

In some embodiments, for an ELR PPDU, when the BSS color is signaled in the ELR-C, the BSS color is not signaled in the ELR-SIG. In these embodiments, the device may use the ELR-C and not the ELR-SIG to determine the BSS color. In some embodiments, when the BSS color is signaled in the ELR-C, the ELR-STF or the ELR-LTF, the BSS color is not signaled in the ELR-SIG. In some embodiments, the ELR-SIG includes a CRC field for validation.

In some embodiments, for an ELR PPDU, the device may determine a finer resolution version of at least one of the BSS color and the TXOP duration by decoding a BSSID and TXOP duration in the MAC header of the MPDU present in the ELR-DATA. In these embodiments, when the device is able to determine the finer resolution version of at least one of the BSS color and the TXOP duration from the MAC header of the MPDU, the device may use the finer resolution version the BSS color and the finer resolution of the TXOP duration for setting the NAV of the device.

In some embodiments, for an ELR PPDU when the TXOP duration is unavailable or unable to be determined, the device may use a PPDU duration derived from a length field in the L-SIG for setting the NAV (e.g., for deferral) if the L-SIG is validated (i.c., using a parity check). In these embodiments, when the L-SIG is not able to be validated and when the TXOP duration is unavailable or unable to be determined, the device may use a PPDU duration derived from a length field in the ELR-SIG for setting the NAV (if the ELR-SIG is validated).

In some embodiments, for an ELR PPDU when the TXOP duration and PPDU duration are unavailable because the L-SIG is not able to be validated and the ELR-SIG is not able to be validated, the device may update the NAV based on a predetermined minimum duration that is longer than a current NAV time when a BSS color of the device does not match a BSS color indicated in the ELR-C and may update the NAV according to a duration determined from one of the U-SIG, the ELR-SIG and the MAC header of the MPDU (i.c., not update the NAV with the predetermined minimum duration) when the BSS color of the device matches the BSS color indicated in the ELR-C.

In some embodiments, the predetermined minimum duration is zero. In some embodiments, the predetermined minimum duration may range from zero microseconds to up to an SIFS+2 MAC slot times. In these embodiments, an SIFS may be 16 microseconds, and one MAC slot time may be 9 microseconds, although the scope of the embodiments is not limited in this respect as different SIF times and MAC slot times may be different for different configurations of channels, bandwidth, and PHY versions.

In some embodiments, for an ELR PPDU when the TXOP duration is unavailable or unable to be determined, the device may fall back to an energy detect (ED) clear channel assessment (CCA) or a packet detect (PD) CCA again without deferral and set the NAV to predetermined minimum duration of zero, although the scope of the embodiments is not limited in this respect as values other than zero may be used.

In some embodiments, when the U-SIG is not able to be validated and when the detected PPDU is not able to be determined to be an ELR PPDU by autoclassification using a signal structure of the ELR preamble portion of the ELR PPDU, the device may update the NAV of the device to defer any transmission for at least a duration indicated in the L-SIG and/or the RL-SIG (i.e., to prevent interfering with another STA's reception of the on-going PPDU).

As shorter version of the TXOP duration may also signaled in the U-SIG and may be used if the U-SIG is able to be validated.

In some embodiments, the detected PPDU may be determined to be an ELR PPDU, the estimated power level of the ELR data field may be determined based on received signal strength of an L-STF and/or an L-LTF of the ELR PPDU and subtracting a predetermined power boost level of the L-STF and/or the L-LTF. In these embodiments, the detected PPDU may be determined to be a non-ELR PPDU that is not an.11ax extended range (ER) PPDU, the estimated power level of the data field may be determined based on received signal strength of at least one of L-STF and a L-LTF without using a predetermined power boost level predetermined power level subtraction (i.e., without a 3 dB subtraction).

In some embodiments, the predetermined power boost level of the L-STF and/or the L-LTF of an EPR PPDU is 3 dB, although the scope of the embodiments is not limited in this respect. In these embodiments, the predetermined power boost level is known at the receiver after the PPDU type classification (i.e., the detected PPDU may be determined to be an ELR PPDU).

In some embodiments, when the detected PPDU may be determined to be an ELR PPDU by autoclassification, the estimated power level of the ELR data field may be determined based on a direct received signal strength measurement of one of an ELR SIG and the ELR data field.

In some embodiments, for a spatial reuse transmission, a transmit (TX) power level may be determined by the device based on the estimated power level for the data field. In these embodiments, for the spatial reuse transmission, the estimated power level for the data field is compared to one or more predetermined power detection levels (e.g., a spatial reuse group (SRG) overlapping basic service set (OBSS) power detection (PD) level or a non-SRG OBSS PD level) for determining the TX power level (e.g., a power level reduction).

In some embodiments, the device may be configured to determine whether a spatial reuse transmission by the device is permitted based on the estimated power level of the data field. When permitted, the device may refrain from updating the NAV and be configured to perform the spatial reuse transmission with a transmit power level reduction based on the estimated power level of the data field.

If an ELR PPDU has a power boosted preamble and a 4× repetition on data symbols, a receiver can work at a SNR lower than the legacy modulation and coding scheme (MCS) 0 by 3-6 dB. The SNR may be lower by 6-9 dB. As a result, it is more challenging to detect the preamble at such a lower SNR. Power boosting the legacy short training field (L-STF) by 3-6 dB may be insufficient to achieve a 6-9 dB improvement. Embodiments disclosed herein provide for detection of the preamble at lower SNR.

Some embodiments disclosed herein replace the L-STF by a new signal. As long as the periodicity of the signal is 0.8 microsecond (i.e., the same as the L-STF), a legacy device should be able to detect it because autocorrelation is used. For further power boosting beyond 3 dB, the new signal may have a constant modulus and smooth phase variation such that the out-of-band emission may be minimized when power boosting is applied. Furthermore, in these embodiments, the autoclassification signal may be power boosted for reliability.

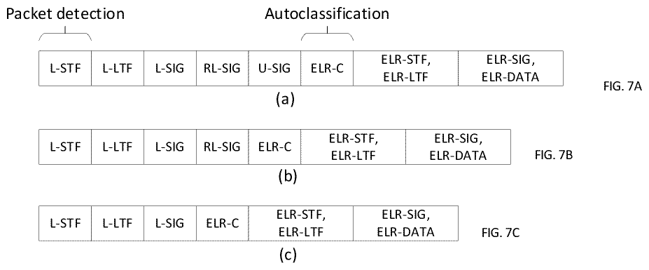

Various preamble structures of an ELR PPDU are shown in FIG. 7A, FIG. 7B and FIG. 7C. Packet detection may be done at the L-STF and the autoclassification may be done at the ELR-C. The differences among the options for an ELR PPDU shown in options FIG. 7A, FIG. 7B and FIG. 7C are whether to skip some the legacy fields (e.g., the U-SIG and the RL-SIG). Embodiments disclosed herein focus on the signal designs for packet detection and autoclassification.

### Packet Detection

For receiving a weak signal, the transmission power of the L-STF

may be boosted. The power boosting is with respect to the transmission power of the data portion of the PPDU. Due to the nonlinearity of the power amplifier, the boosted signal may get distorted such that it is challenging to meet the power spectrum mask defined by IEEE 802.11 or regulations.

It is noticed that the packet detection mainly relies on the periodicity of the L-STF, i.e., the period of 0.8 microsecond, instead of the exact waveform of the L-STF. Because of the large, initial carrier frequency offset (CFO) and the multipath interference, the received L-STF may be highly distorted such that packet detection using cross correlation doesn't work well. Therefore, autocorrelation, which relies on the periodicity or repetition, is widely used for the packet detection. Exploiting the repetition structure of the L-STF signal, the autocorrelation projects a delayed copy of the previous signal to the current signal to identify the signal repetition. This implies that any signal with the same 0.8 microsecond periodicity can serve the purpose of packet detection.

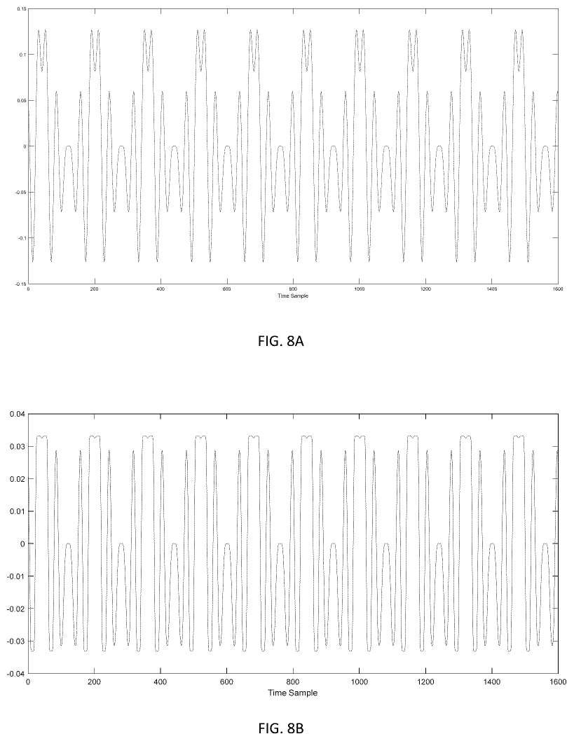

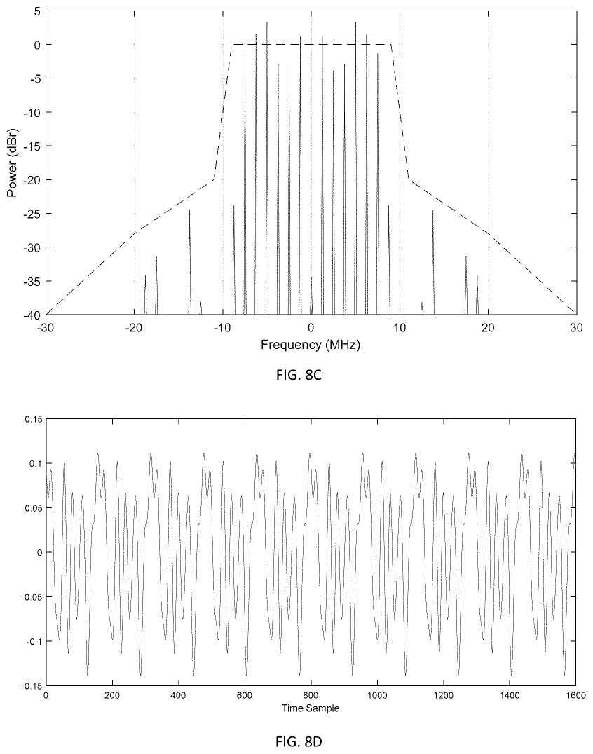

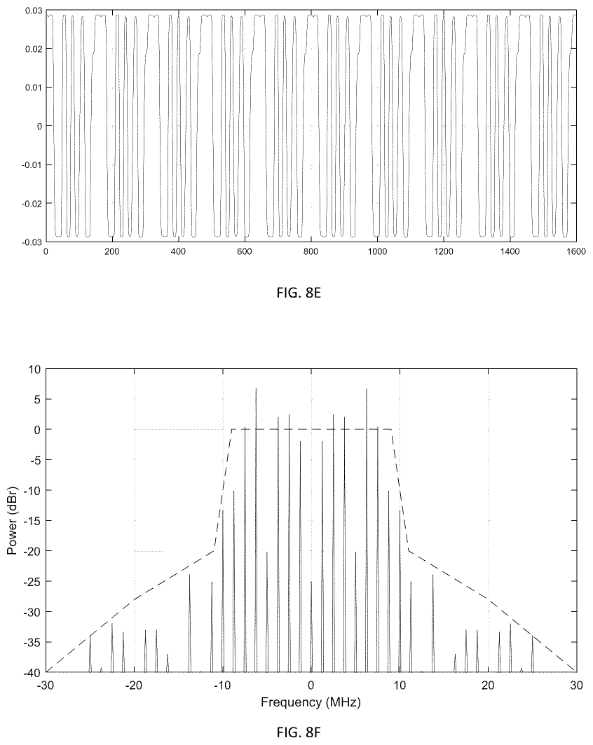

Because the L-STF signal is an OFDM signal, its peak to average power ratio (PAPR) is not as low as the signal with a constant modulus. Therefore, the peaks of the time-domain L-STF signal as shown in FIG. 8A are vulnerable to the clipping or distortion introduced by the power amplifier nonlinearity. The distorted L-STF is illustrated in FIG. 8B. As a result, the distortion causes out-of-band emissions such that the power boosting level is limited by the power spectrum mask defined by the spec and regulations. The power spectrum mask and the power spectrum of the distorted L-STF signal of FIG. 8B are illustrated in FIG. 8C. It is observed that the distorted signal in FIG. 8B has a lower PAPR than the original one in FIG. 8A, i.e., PAPR 2.4 vs PAPR 3.2. Furthermore, the distorted one in FIG. 8B still meets the power spectrum mask in dash line as seen from FIG. 8C. Finally, the correlation between the distorted and the original is 0.94. Namely, devices using cross correlation still works fine with the distorted. All these suggest that the distorted signal can replace the original L-STF for ELR packet detection. In FIG. 8C, note that unlike the L-STF, the amplitudes of symbols on the active subcarriers within the allocated 20 MHz channel are not constant.

For further power boosting, embodiments disclosed herein may replace the original L-STF signal by other signals with lower PAPR such that the tolerance to power boosting gets improved. The new signal should meet two requirements: 1) the signal should have the same periodicity as the L-STF signal (i.e., 0.8 microsecond period). In addition, it may have the same duration as the L-STF signal, i.e., 10 periods. 2) The signal may need to meet the power spectrum mask of 802.11 or regulations. Besides these two requirements, two features are desired. 1) It is desirable that the new signal has a high correlation with L-STF such that legacy devices using cross correlation can still detect it. 2) The autocorrelation of the new signal should like the delta function such that the symbol boundary may be clearly detected. Namely, when the two copies of the signal have a time offset like 1 sample, the correlation or inner product of the two drops significantly so that the offset may be easily detected.

Example embodiments of such signals are described below and include Pulse Sequence, Pulse Sequence with Reduced Phase Transition, Constant Modulus Signal, and Modified L-STF,

### Pulse Sequence

Phase modulation has lower PAPR than amplitude modulation and OFDM. An example of phase modulated signals is a sequence of phase coded pulses (SPCP). The sequence consists of pulses whose phases vary with time. The phases of the code may be binary or polyphase like QPSK and 8PSK. The Barker code sequence used by 802.11b is a sequence of pulses with binary phase, i.e., − and +. The transmitted signal is a sequence of BPSK modulated pulses. The autocorrelation of the Barker code is optimized to be close to the delta function. Variants of Barker code include generalized Barker code or polyphase Barker code. Other codes with delta like autocorrelation include Golay codes used in wireless systems. Because the pulse shape determines the out-of-band emission (OBE), the rectangle is not an undesirable pulse and optimization is needed to get smooth pulse shapes, e.g., like raised cosine pulse or square root of raised cosine pulse. Many new signal can be generated using different codes and pulse shapes. Passing the generated signals to the power amplifier model with power boosting, the performances of the signals can be checked, and then the signals with good performance can be selected to replace the L-STF. The selected code with binary phase or polyphase should tolerate the highest power boosting while meeting the first and second requirements and not delivering the worst performances for features one and two.

Pulse Sequence with Reduced Phase Transition

The phase transition of BPSK barker code like 802.11b may be up to 180 degrees. This is undesirable because it can cause out-of-band emission (OBE) if the pulse shape is not properly designed. Besides, it can increase the PAPR. There exist better ways to send the codes, which may have delta like autocorrelation or result in signals highly correlated with L-STF, with reduced phase transitions such that the OBE and PAPR are reduced. For example, the codes may be sent by modulation techniques with asynchronous (or offset) phase switching like offset QPSK (OQPSK) or π/4QPSK. In sending the code bits, the phase transitions of I component and Q component carrying the code bits occur at different times. This reduces the phase transition of the RF signal such that both the OBE and the PAPR get reduced. Many new signal can be generated using different codes and phase-transition reduced modulation. Passing the generated signals to the power amplifier model with power boosting, the performances of the signals can be checked, and then the signals with good performance can be selected to replace the L-STF. The selected code and modulation should tolerate the highest power boosting while meeting the first and second requirements and not delivering the worst performances for features one and two.

### Constant Modulus Signal

The phase change of BPSK, QPSK, QPSK (OQPSK), and π/4QPSK is not so smooth such that out-of-band emission (OBE) is incurred. For OBE and PAPR reduction, smooth phase variation is desired. One example of smooth phase modulation is minimum-shift keying (MSK) and its variant GMSK, which is used in the 2G GSM system. MSK has small out-of-band emissions such that it can meet the power spectrum requirement of 802.11 easily. GMSK further improves the out-of-band emission (OBE) of MSK. Both MSK and GMSK solve the OBE problem nicely. Similar to the aforementioned design method, many new signals can be generated by modulating different codes using the MSK or GMSK. Passing the generated signals to the power amplifier model with power boosting, the performances of the signals can be checked, and then the signals with good performance can be selected to replace the L-STF. The selected code and modulation should tolerate the highest power boosting while meeting Requirements one and two and not delivering the worst performances for Features one and two.

If the replacement signal of L-STF or ELR fields like ELR-C, ELR-STF, ELR-LTF is to carry few bits of information like 16 bits, the constant modulus modulations (e.g., OQPSK, π/4QPSK, MSK, GMSK) are desirable. The bits are sequentially sent over time. If the bits do not need to be sent sequentially, then other waveforms may be desirable. Another big family of smooth phase signals are linear frequency-modulated pulse sequence and non-linear frequency-modulated pulse sequence. The phase varies smoothly, e.g., a constant second derivative. A good example of linear frequency-modulated pulse sequence is the chirp-like phase code, c.g., Frank code and the famous Zadoff-Chu code, which is used in 3GPP LTE. For linear frequency-modulated pulse sequences, the frequency of the signal linearly increases or decreases as the time increases. For sending information bits, different codes or waveforms may be used to send different messages, respectively.

An example of how to generate the packet detection signal using Zadoff-Chu code is described. In this example, a length 17 code is selected and truncated to length 16. It should be noticed that the truncation or repetition of the code may not be needed if a length 16 code is selected. The root of Zadoff-Chu code in this example is one. The baseband time-domain waveform of the generated signal is shown in FIG. 8D. Compared to FIG. 8A, there are fewer samples with small and medium amplitudes in FIG. 8D than FIG. 8A. This improves the PAPR. The ideal signal should stay on the maximum amplitude. The output signal of the power amplifier, which has distortion, is shown in FIG. 8E. Compared to FIG. 8B, it may be seen that more samples in FIG. 8E stay at the maximum amplitudes than FIG. 8B. In addition, the actual output power in FIG. 8E is higher than the one in FIG. 8B by about 2 dB for the same power amplifier. Therefore, the Zadoff-Chu signal is more desirable for the power boosting than the L-STF signal, allowing additional 1-2 dB power boosting. Finally, the power spectrum of the signal in FIG. 8E is shown in FIG. 8F. It is confirmed that the distorted Zadoff-Chu signal meets the mask in dash line. In summary, the Zadoff-Chu signal meets the two requirements, i.e., Requirements one and two. Regarding the two features, the Zadoff-Chu signal doesn't have an autocorrelation as good as the L-STF and the cross correlation with the L-STF is not very high, i.c., 0.52. Namely, the legacy device using cross correlation may have a degradation in packet detection and the symbol boundary of the 0.8 microsecond symbols may not be detected accurately. Further optimization may be done to improve the performances of the two features. For example, Zadoff-Chu codes with different lengths like 15 and 16, and different roots like 3 may be used to generate the replacement signal of L-STF by truncation, repetition, and cyclic shift. Using the truncation, repetition, and cyclic shift, many new signals can be generated. Passing the generated signals to the power amplifier model with power boosting, the performances of the signals can be checked, and the signals with good performance can be selected to replace the L-STF. The selected code and modulation should tolerate the highest power boosting while meeting requirements one and two and delivering the reasonable performances for features one and two

### Modified L-STF

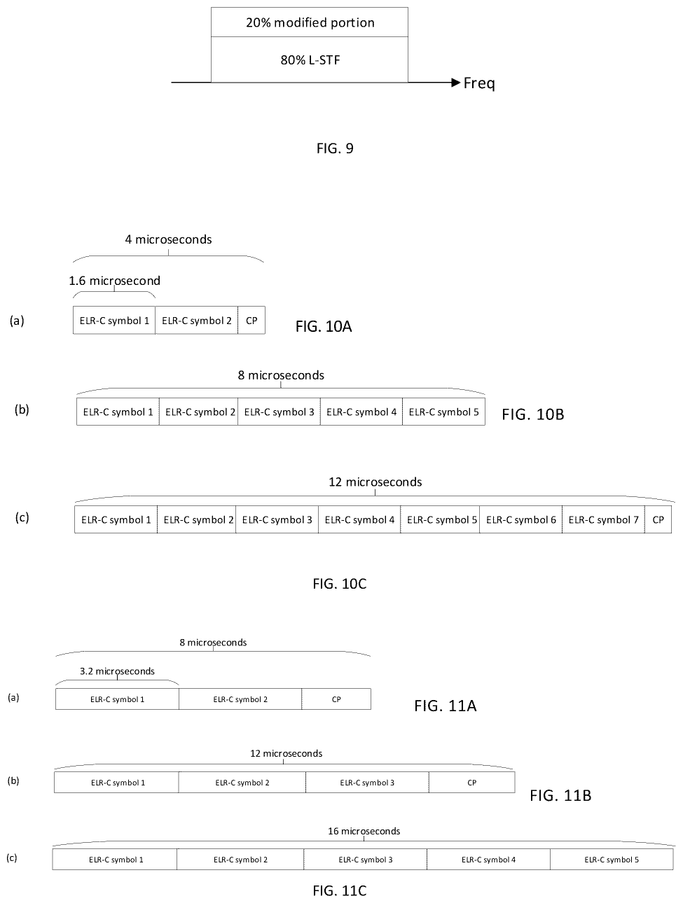

Another simple way to improve the power boosting tolerance of the L-STF is to keep the most part of the L-STF and modify a small portion of it as illustrated in FIG. 9. Keeping the most part of the L-STF guarantees a high cross correlation with the L-STF. The modified portion improves the power boosting tolerance. For the example in FIGS. 8A-8C, the modified L-STF of FIGS. 8B-8C improves the power boosting tolerance of the L-STF. FIG. 8C is an example of FIG. 9. Few methods for how to search for the modified L-STF are described.

### Method 1—Fully Random

In the search, let the generated signal in frequency domain be x(f)=γ·s(f)+\sqrt{1−γ²}·n(f), where f=−8, . . . , 8 is the active subcarrier index, s(f) is the L-STF signal for subcarrier f in frequency domain, n(f) is a random variable with zero mean and the same power as s(f) for subcarrier f, γ is the target cross correlation between the modified signal and L-STF. n(f) may be of Gaussian distribution. Passing the generated signals to the power amplifier model with power boosting, the performances of the signals can be checked, and the signals with good performance can be selected to replace the L-STF. The selected signal x₀(f) should tolerate the highest power boosting while meeting requirements one and two and delivering reasonable performances for features one and two.

### Method 2—Multipath Filter

In the search, the L-STF signal may be passed through a multipath channel, which is defined by complex multipath gains aₗ, and time shifts, delay lTₛ for the l-the multipath for l=1, . . . , L, Tₛ is the sampling time. Let the generated signal be x(f)=γ·s(f)+s(f)Σₗ₌₁^{L} aₗ·e^{-j2πflT}^{ₛ}, where aₗ is multipath gain for l=1, . . . , L, Σₗ₌₁^{L}|aₗ|²=1−γ² is total power of the multipaths except the first. Passing the generated signals to the power amplifier model with power boosting, the performances of the signals can be checked, and the signals with good performance can be selected to replace the L-STF. The selected signal x₀(f) should tolerate the highest power boosting while meeting Requirements one and two and delivering reasonable performances for Features one and two. Because there are multipaths in the real channels, the multipaths added in the search essentially create a multipath channel with longer delay spread, where the receive should be able to operate.

### Method 3—Phase Change

In the search, the phases of L-STF may be randomly changed on few subcarriers and/or remove the L-STF signals on some subcarriers. Passing the generated signals to the power amplifier model with power boosting, the performances of the signals can be checked, and the signals with good performance can be selected to replace the L-STF. The selected signal x₀(f) should tolerate the highest power boosting while meeting Requirements one and two and delivering reasonable performances for Features one and two.

### Autoclassification

The field ELR-C in FIG. 8A is for autoclassification. The autoclassification field specifies the PPDU type of the receiving PPDU. Embodiments disclosed herein combine the ELR-C field with the ELR-STF for improving efficiency. The reasons are as follows. The ELR-STF is for resetting the AGCA when the previous PPDU portion before ELR-STF is not beamformed and the rest is beamformed. First, it is desired that the whole ELR PPDU is beamformed such that the packet detection at the very beginning of the PPDU gets improved to avoid being the bottleneck of the reception. In this case, there is no significant power level change between the legacy portion, i.e., L-STF/L-LTF/L-SIG/RL-SIG/U-SIG, and the ELR portion of the ELR PPDU, i.e., ELR-STF, ELR-STF. ELR-LTF, ELR-SIG, ELR-DATA, because the whole PPDU is beamformed by the same antenna weights. Therefore, ELR-STF is not needed because the AGCA is already set at the very beginning of the PPDU. Second, even if the portion before ELR-STF is not beamformed and the rest of PPDU is beamformed, the received power should not change significantly, e.g., 9 dB, because 1) the number of antennas is limited, e.g., 2 or 4, 2) the L-STF or its replacement signal is power boosted by 3-9 dB, and 3) the beamforming weights limit or reduced the output powers of the power amplifiers for the beamformed portion. Therefore, the ELR-STF may not be needed or may be combined with the ELR-C. Furthermore, embodiments disclosed herein beamform the entire PPDU starting from the very beginning.

If it is decided to keep the ELR-STF, in some embodiments, the ELR-C is not beamformed and sent with cyclic-shift diversity (CSD) when multiple transmit antennas are used. In embodiments disclosed herein, a portion of the PPDU before the ELR-STF is not beamforming and sent with CSD when multiple transmit antenna are used.

For enhancing reliability, the transmit power of ELR-C, ELR-STF, and ELR-LTF may be boosted. Because these fields consist of fixed signals known to the receiver, these fields may be optimized for power boosting. Because the data field, ELR-DATA, is likely to use repetition in frequency domain, techniques like phase/bit masking and CSD may be applied to the repeated signals for reducing their PAPR. As a result, the data field ELR-DATA may be power boosted as well.

FIG. 10A, FIG. 10B and FIG. 10C illustrate embodiments of an ELR-C field with a 1.6 microsecond period, in accordance with some embodiments. The duration of the field is a multiple of 4 microseconds for aligning the OFDM symbol boundary of the legacy devices. The three options illustrated in FIG. 10A, FIG. 10B and FIG. 10C each have a different duration. The longer the more reliable for the autoclassification and AGC fine tuning. However, the longer the larger the overhead. The period of the ELR-C is 1.6 microsecond in FIG. 10A, FIG. 10B and FIG. 10C. It may be extended to 3.2 microseconds as shown in FIG. 11A, FIG. 11B and FIG. 11C.

FIG. 11A, FIG. 11B and FIG. 11C illustrate embodiments of an ELR-C field with a 3.2 microsecond period, in accordance with some embodiments. The longer the period the more accurate the CFO correction is needed. For accurate CFO correction, it is desired to power boost the pilot signals in ELR-C and before ELR-C. Periods other than 1.6 and 3.2 microseconds like 1.2 microsecond may be used but the period can't be 0.8 microsecond because it will falsely trigger the legacy devices.

For the power boosting, the PAPR of ELR fields with signals known to the receiver should be minimized. If OFDM is used for the field(s), the symbol sequence(s) of the field(s) applied on subcarriers in frequency domain should have delta like autocorrelation, which results in small sidelobes. If the modulation doesn't need to be OFDM, the modulation types for the packet detection, e.g., pulse sequence, pulse sequence with reduced phase transition, and constant modulus signal, may be reused for ELR-C signal. Constant modulus signal with smooth phase variation like Zadoff-Chu code and other chirp like signals is also desired. The ELR-C may have an even number of periods for the ease of autocorrelation. The period may be 1.6 microseconds, or 3.2 microseconds and the field duration may be multiple of 4 microseconds for the ease of symbol boundary alignment in multiuser scenarios like MU-MIMO or OFDMA.

In some embodiments, the total duration of ELR-C may be restricted to 8, 12, and 16 microseconds. The remainder of the total duration divided by the ELR-C symbol duration may be used as CP. In some cases, the remainder is zero such that there is no CP. For example, the ELR-C illustrated in FIG. 10B and FIG. 11C does not include CP.

### Pilot

For correcting the carrier frequency offset (CFO), pilot signal is used. Because the received signal of ELR is weak and the number of pilot subcarriers is small, e.g., 4, it is challenging to estimate the CFO accurately. Therefore, embodiments disclosed herein may boost the pilot signals in L-LTF, L-SIG, RL-SIG, U-SIG, ELR-LTF, ELR-DATA, and maybe ELR-C as well. With the CFO compensation, the reliability of the autoclassification and phase rotation correction over the data field may be improved. The power boosting of the pilots may be 3-9 dB.

In some embodiments, an ELR PPDU may comprise a legacy preamble portion followed by a ELR preamble portion and an ELR data field (ELR-DATA) following the ELR preamble portion (see FIG. 7A, FIG. 7B and FIG. 7C). The legacy preamble portion may comprise a legacy short training field (L-STF) followed by a legacy long training field (L-LTF), and a legacy signal field (L-SIG). The ELR preamble portion may comprise an ELR classification field followed by an ELR-STF, an ELR-LTF and an ELR-SIG. In some embodiments, the L-STF may have a 0.8 microsecond periodicity, the L-STF and the ELR-C may both comprise a sequence of phase coded pulses (SPCP) applied on subcarriers in frequency domain, and the ELR-C may have a duration of one or more multiples of 4 microseconds (see FIG. 11A, FIG. 11B and FIG. 11C). In some embodiments, when multiple antennas are used to transmit the ELR PPDU and when the ELR-STF is included in the ELR PPDU, the transmitting device may refrain from beamforming the legacy preamble portion and the ELR-C, and may perform beamforming on the ELR-STF, ELR-LTF, the ELR-SIG and the ELR-DATA, although the scope of the embodiments is not limited in this respect.

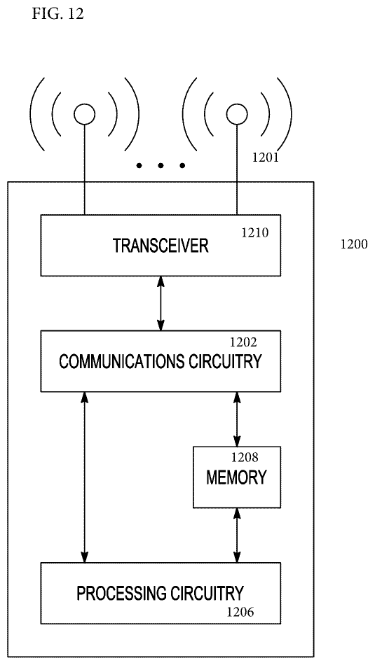

FIG. 12 illustrates a functional block diagram of a wireless communication device, in accordance with some embodiments. Wireless communication device 1200 may be suitable for use as a UE or gNB configured for operation in a 5G NR or 6G network. In some embodiment, FIG. 12 illustrates a functional block diagram of a communication device (STA) that may be suitable for use as an AP STA, a non-AP STA or other user device in accordance with the embodiments described herein. The wireless communication device 1200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device. In some embodiments, the wireless communication device 1200 may be configured for Ultra-High Reliability (UHR) communications in accordance with an IEEE 802.11 (e.g., WiFi 8). Some embodiments are directed to an apparatus of a STA configured for operation in a WLAN comprising processing circuitry and memory.

The wireless communication device 1200 may include communications circuitry 1202 and a transceiver 1210 for transmitting and receiving signals to and from other communication devices using one or more antennas 1201. The communications circuitry 1202 may include circuitry that can operate the physical layer (PHY) communications and/or medium access control (MAC) communications for controlling access to the wireless medium, and/or any other communications layers for transmitting and receiving signals. The wireless communication device 1200 may also include processing circuitry 1206 and memory 1208 arranged to perform the operations described herein. In some embodiments, the communications circuitry 1202 and the processing circuitry 1206 may be configured to perform operations detailed in the above figures, diagrams, and flows.

In accordance with some embodiments, the communications circuitry 1202 may be arranged to contend for a wireless medium and configure frames or packets for communicating over the wireless medium. The communications circuitry 1202 may be arranged to transmit and receive signals. The communications circuitry 1202 may also include circuitry for modulation/demodulation, upconversion/downconversion, filtering, amplification, etc. In some embodiments, the processing circuitry 1206 of the wireless communication device 1200 may include one or more processors. In other embodiments, two or more antennas 1201 may be coupled to the communications circuitry 1202 arranged for sending and receiving signals. The memory 1208 may store information for configuring the processing circuitry 1206 to perform operations for configuring and transmitting message frames and performing the various operations described herein. The memory 1208 may include any type of memory, including non-transitory memory, for storing information in a form readable by a machine (e.g., a computer). For example, the memory 1208 may include a computer-readable storage device, read-only memory (ROM), random-access memory (RAM), magnetic disk storage media, optical storage media, flash-memory devices and other storage devices and media.

In some embodiments, the wireless communication device 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 1200 may include one or more antennas 1201. The antennas 1201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 1200 may include one or more of a keyboard, a display, a non-volatile memory port, multiple antennas, a graphics processor, an application processor, speakers, and other mobile device elements. The display may be an LCD screen including a touch screen.

Although the wireless communication device 1200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 1200 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless communication device configured for communication in a wireless local area network (WLAN), the apparatus comprising:
processing circuitry; and memory, wherein the processing circuitry is configured to:
determine whether a detected physical layer protocol data unit (PPDU) is an enhanced long range (ELR) PPDU or a non-ELR PPDU;
estimate a power level for a data field of the detected PPDU; and
use the estimated power level for the data field for determining a physical layer clear channel assessment (PHY-CCA) indication primitive,
wherein when an ELR PPDU is detected, the data field is an ELR data field and the estimated power level for the ELR data field is determined based on one or more predetermined power boost levels of one or more fields in the ELR PPDU.

2. The apparatus of claim 1, wherein the ELR PPDU comprises a legacy preamble portion followed by a ELR preamble portion,
the legacy preamble portion comprising a legacy short training field (L-STF), followed by a legacy long training field (L-LTF), a legacy signal field (L-SIG), a repetition of the L-SIG (RL-SIG), and a universal signal field (U-SIG),
the ELR preamble portion comprising an ELR classification field (ELR-C) followed by an ELR-STF an ELR-LTF and an ELR-SIG,
the ELR data field (ELR-DATA) following the ELR preamble portion, and
wherein the L-STF and the L-LTF are power boosted at transmission by a first predetermined power boost level compared to the L-SIG, the RL-SIG, the U-SIG, the ELR-SIG, and ELR-DATA.

3. The apparatus of claim 2, wherein the detected PPDU is determined to be an ELR PPDU by autoclassification using the ELR-C.

4. The apparatus of claim 3, wherein when the detected PPDU is determined to be an ELR PPDU, and when the U-SIG is unable to be decoded correctly, the processing circuitry is configured update a network allocation vector (NAV) of the device based on a basic service set (BSS) color and signaled in one or more fields of the ELR preamble portion and a transmission opportunity (TXOP) duration signaled in a header of an MPDU present in the ELR-DATA; and
wherein when the detected PPDU is determined to be a non-ELR PPDU, the processing circuitry is configured to update the NAV of the device based on a BSS color and a TXOP duration field signaled in the U-SIG of the non-ELR PPDU.

5. The apparatus of claim 4, wherein for an ELR PPDU, when the BSS color is signaled in the ELR-C, the BSS color is not signaled in the ELR-SIG, and
wherein the ELR-SIG includes a CRC field.

6. The apparatus of claim 4, wherein for an ELR PPDU, the processing circuitry is further configured to determine a finer resolution version of at least one of the BSS color and the TXOP duration by decoding a BSSID and TXOP duration in the header of the MPDU present in the ELR-DATA,
wherein when the processing circuitry is able to determine the finer resolution version of at least one of the BSS color and the TXOP duration from the header of the MPDU, the processing circuitry is configured to use the finer resolution version the BSS color and the finer resolution of the TXOP duration for setting the NAV of the device.

7. The apparatus of claim 4, wherein for an ELR PPDU when the TXOP duration is unavailable or unable to be determined, the processing circuitry is configured to use a PPDU duration derived from a length field in the L-SIG for setting the NAV if the L-SIG is validated, and
wherein when the L-SIG is not able to be validated and when the TXOP duration is unavailable or unable to be determined, the processing circuitry is configured to use a PPDU duration derived from a length field in the ELR-SIG for setting the NAV.

8. The apparatus of claim 4, wherein for an ELR PPDU when the TXOP duration and PPDU duration are unavailable because the L-SIG is not able to be validated and the ELR-SIG is not able to be validated, the processing circuitry is configured to:
update the NAV based on a predetermined minimum duration that is longer than a current NAV time when a BSS color of the device does not match a BSS color indicated in the ELR-C, and
update the NAV according to a duration determined from one of the U-SIG, the ELR-SIG and the header of the MPDU when the BSS color of the device matches the BSS color indicated in the ELR-C,
wherein the predetermined minimum duration is configurable to be as low as zero.

9. The apparatus of claim 4, wherein for an ELR PPDU when the TXOP duration is unavailable or unable to be determined, the processing circuitry is configured fall back to an energy detect (ED) clear channel assessment (CCA) or a packet detect (PD) CCA without deferral and set the NAV to predetermined minimum duration of zero.

10. The apparatus of claim 9, wherein when the U-SIG is not able to be validated and when the detected PPDU is not able to be determined to be an ELR PPDU by autoclassification using a signal structure of the ELR preamble portion of the ELR PPDU, the processing circuitry is configured to update the NAV of the device to defer any transmission for at least a duration indicated in the L-SIG and/or the RL-SIG.

11. The apparatus of claim 4, wherein the detected PPDU is determined to be an ELR PPDU, the estimated power level of the ELR data field is determined based on received signal strength of an L-STF and/or an L-LTF of the ELR PPDU and subtracting a predetermined power boost level of the L-STF and/or the L-LTF, and
wherein the detected PPDU is determined to be a non-ELR PPDU that is not an extended range (ER) PPDU, the estimated power level of the data field is determined based on received signal strength of at least one of L-STF and a L-LTF without using a predetermined power boost level predetermined power level subtraction.

12. The apparatus of claim 4, wherein when the detected PPDU is determined to be an ELR PPDU by autoclassification, the estimated power level of the ELR data field is determined based on a direct received signal strength measurement of one of an ELR SIG and the ELR data field.

13. The apparatus of claim 2, wherein for a spatial reuse transmission, a transmit (TX) power level is determined by the device based on the estimated power level for the data field,
wherein for the spatial reuse transmission, the estimated power level for the data field is compared to one or more predetermined power detection levels for determining the TX power level,
wherein the processing circuitry is configured to determine whether a spatial reuse transmission by the device is permitted based on the estimated power level of the data field,
when permitted, the processing circuitry is configured to refrain from updating a network allocation vector (NAV) of the device and configure the device to perform the spatial reuse transmission with a transmit power level reduction based on the estimated power level of the data field.

14. The apparatus of claim 2, wherein the L-STF has a 0.8 microsecond periodicity,
wherein the L-STF and the ELR-C both comprise a sequence of phase coded pulses (SPCP) applied on subcarriers in frequency domain, and
wherein the ELR-C has a duration of one or more multiples of 4 microseconds

15. A non-transitory computer-readable storage medium that stores instructions for execution by processing circuitry of a wireless communication device configured for communication in a wireless local area network (WLAN), wherein the processing circuitry is configured to:
determine whether a detected physical layer protocol data unit (PPDU) is an enhanced long range (ELR) PPDU or a non-ELR PPDU;
estimate a power level for a data field of the detected PPDU; and
use the estimated power level for the data field for determining a physical layer clear channel assessment (PHY-CCA) indication primitive,
wherein when an ELR PPDU is detected, the data field is an ELR data field and the estimated power level for the ELR data field is determined based on one or more predetermined power boost levels of one or more fields in the ELR PPDU.

16. The non-transitory computer-readable storage medium of claim 15, wherein the ELR PPDU comprises a legacy preamble portion followed by a ELR preamble portion,
the legacy preamble portion comprising a legacy short training field (L-STF), followed by a legacy long training field (L-LTF), a legacy signal field (L-SIG), a repetition of the L-SIG (RL-SIG), and a universal signal field (U-SIG),
the ELR preamble portion comprising an ELR classification field (ELR-C) followed by an ELR-STF an ELR-LTF and an ELR-SIG,
the ELR data field (ELR-DATA) following the ELR preamble portion, and
wherein the L-STF and the L-LTF are power boosted at transmission by a first predetermined power boost level compared to the L-SIG, the RL-SIG, the U-SIG, the ELR-SIG, and ELR-DATA.

17. The non-transitory computer-readable storage medium of claim 16, wherein the detected PPDU is determined to be an ELR PPDU by autoclassification using the ELR-C.

18. An apparatus for a station (STA) comprising: processing circuitry and memory, wherein the processing circuitry is configured to:
encode an enhanced long range (ELR) PPDU for transmission, the ELR PPDU comprising a legacy preamble portion followed by a ELR preamble portion, and an ELR data field (ELR-DATA) following the ELR preamble portion,
wherein the legacy preamble portion comprises a legacy short training field (L-STF) followed by a legacy long training field (L-LTF), a legacy signal field (L-SIG), a repeated legacy signal field (RL-SIG), and a universal signal field (U-SIG);
wherein the ELR preamble portion comprises an ELR classification field (ELR-C) followed by an ELR-STF, an ELR-LTF and an ELR-SIG.

19. The apparatus of claim 18, wherein the L-STF has a 0.8 microsecond periodicity,
wherein the L-STF and the ELR-C both comprise a sequence of phase coded pulses (SPCP) applied on subcarriers in frequency domain, and
wherein the ELR-C has a duration of one or more multiples of 4 microseconds.

20. The apparatus of claim 19, wherein when multiple antennas are used to transmit the ELR PPDU and when the ELR-STF is included in the ELR PPDU, the processing circuitry is configured to:
refrain from beamforming the legacy preamble portion, and the ELR-C, and
perform beamforming on the ELR-STF, ELR-LTF, the ELR-SIG and the ELR-DATA.
